(19) United States
(12) Patent Application Publication
(10) Pub. No.: US 2012/0263845 A1
(43) Pub. Date: Oct. 18, 2012

(54) Solar Steam Cooker

(75) Inventor: Yang Shi, Changzhou (CN)

(73) Assignees: Jianping Wang, Changzhou, Jiangsu (unknown); Yang Shi, Changzhou, Jiangsu (CN)

(21) Appl. No.: 13/321,558

(22) PCT Filed: May 20, 2010
(86) PCT No.: PCT/CN2010/000713

§ 371 Date: Jun. 21, 2012

(30) Foreign Application Priority Data
May 23, 2009 (CN) 200920156078.7
Sep. 22, 2009 (CN) 200910178668.4

(51) Int. Cl. F24J 2/02; F24J 2/42; A23L 1/01; A47J 27/04

(52) U.S. Cl. 426/510; 126/618; 126/369; 126/615

(57) ABSTRACT

The invention provides a solar steam cooker having a solar tube enclosing an inner space and having a close end and an open end, a cover closing the open end, an inner container in the inner space of the solar tube and being rotatable with respect to the solar tube, a sleeve covering on the close end of the solar tube and having an axle, and, a strut supporting the axle of the sleeve. The solar tube is of glass and has a translucent outer layer, a blackbody inner layer and a vacuum space between the outer and the inner layer. The cover has a circular groove covering on the open end of the solar tube. The inner container has a top opening.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to steam heating appliance, and more particularly, to a solar steam cooker.

2. Description of Related Art

There are two mainstream kinds of solar heating appliance in the current market: light focus and non-light focus. light focus type heating appliances always have big in volume and heavy weight; however the non-light focus types always need a very long time to heat water to boiling. Most of time is wasted in heating superfluous water contained which will significantly lower a solar efficiency. Both types are not satisfactory for life needs, such as outdoor cooking.

### BRIEF SUMMARY OF THE INVENTION

The main object of the invention is to provide a solar steam cooker having a higher solar efficiency and shorter heating time.

In order to accomplish the object, the invention provides a solar steam cooker having a solar tube enclosing an inner space and having a close end and an open end, a cover closing the open end, an inner container in the inner space of the solar tube and being rotatable with respect to the solar tube, a sleeve covering on the close end of the solar tube and having an axle, and, a strut supporting the axle of the sleeve. The solar tube is of glass and has a translucent outer layer, a blackbody inner layer and a vacuum space between the outer and the inner layers. The cover has a circular groove covering on the open end of the solar tube. The inner container has a top opening.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1 is a schematic plane cross-sectional view of the preferred embodiment of the cooker of the invention.

FIG. 2 is a side view of an inner container of the cooker shown in FIG. 1.

FIG. 3 is a top view of the inner container of the cooker shown in FIGS. 1 and 2.

FIG. 4 is a side view of another inner container of the cooker.

FIGS. 5 through 7 are top views of inner containers having different spacing.

FIG. 8 is a cross-sectional view of the inner container across line B-B1 shown in FIG. 6.

FIG. 9 is a schematic plane cross-sectional view of the cooker shown in FIG. 1 using a handcrank.

FIG. 10 is a schematic plane cross-sectional view of another embodiment of the cooker of the invention.

FIG. 11 is a schematic plane cross-sectional view of the cooker supported by roller supporters.

FIG. 12 is another cross-sectional view of the cooker shown in FIG. 11.

FIGS. 13 through 15 are side views of the inner containers having several independent compartments. And,

FIG. 16 is a side view of the inner containers shown in FIGS. 13 through 15.

### DETAILED DESCRIPTION OF THE INVENTION

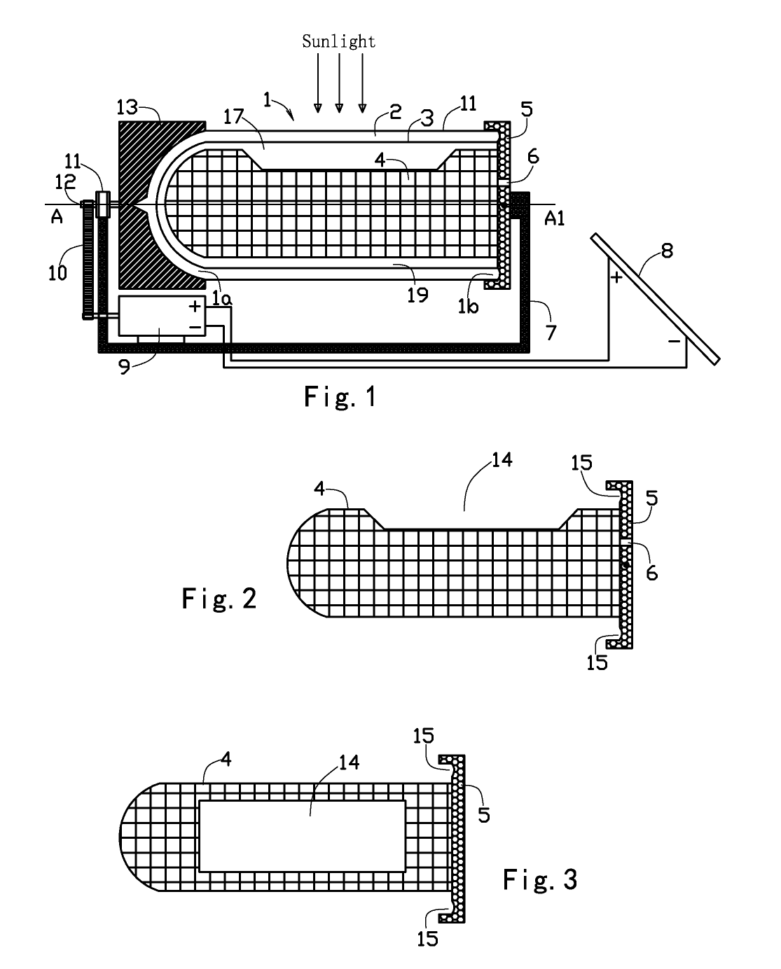

With reference to FIG. 1, a preferred embodiment of a solar steam cooker of the invention is shown. The solar steam cooker has a solar tube 1 enclosing an inner space 17 and having a close end 1a and an open end 1b. The open end 1b is able to be closed by a cover 5. The solar tube 1 is able to be levelly placed on ground. An inner container 4 is provided in the inner space 17 of the solar tube 1, with a clearance 19 being left between an inner surface of the solar tube 1 and the inner container 4. The inner container 4 is able to rotate with respect to the solar tube 1.

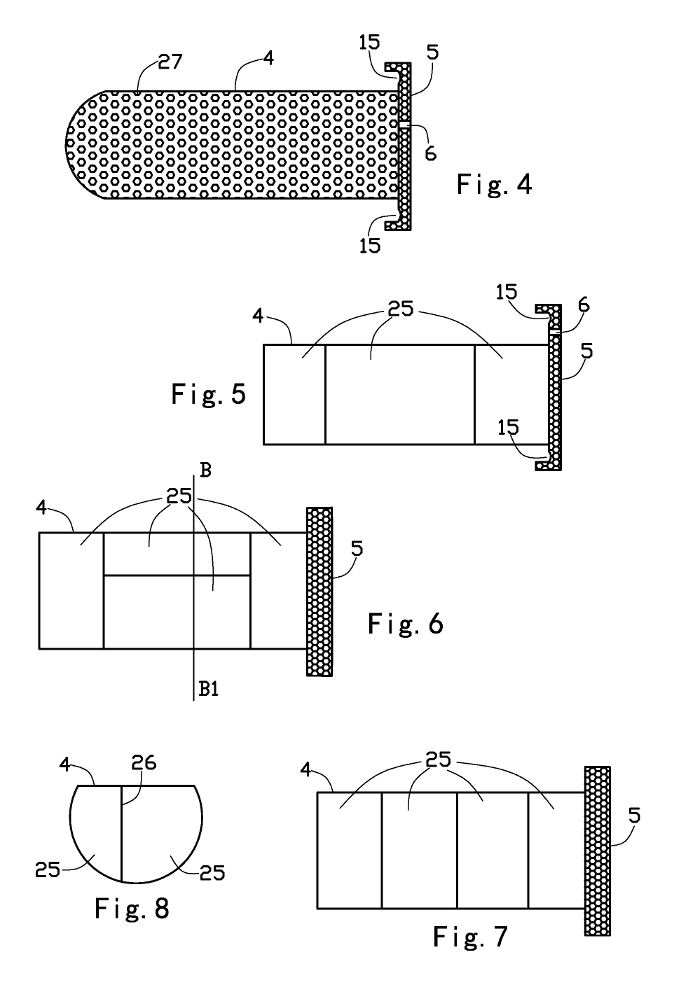

With reference to FIGS. 2 and 3, the inner container 4 has a top opening 14 for putting in or taking out food. The top opening 14 may be of a shape of rectangle as shown in the FIGS. and defined along an axis of the inner container 4. In the embodiment shown in the FIGS., a length of the top opening 14 is smaller than a length of the inner container 4 and a width thereof is smaller than a diameter of the inner container 4. However, actually the length and width of the top opening 14 respectively might be any percent of those of the inner container 4. For example, the length of the top opening 14 may be 60%-90% of the inner container 4 and the width thereof may be 50%-90% of the length of the inner container 4. The inner container 4 may be made of stainless steel or other heat conducting materials. As shown in FIG. 4, a wall of the inner container 4 may be grid or porous with fine holes 27. The holes should be such big that steam will be able pass through but food will not be able to leak.

With reference to FIGS. 5, 6, 7 and 8, another inner container 4 for this preferred embodiment is shown. The inner container 4 is a box having the top opening 14. The inner container 4 is able to be divided into more than one compartment 25 for containing different kinds of food need to be heated. Each compartment 25 is able to be accessed through the top opening 14. As shown in FIG. 5, the inner container 4 is divided into three side by side compartments 25 each of which is accessible through the top opening 14. A middle compartment 25 is larger than the two compartments 25 by its side. Quantity of compartment 25 may be two or more according to actual need. Shown in FIG. 6 is another kind of division of the inner container 4. The inner container 4 is divided into 4 side by side compartments 25. Variety of divisions will be possible, either longitudinal or cross-sectional with respect to the inner container 4.

Shown in FIGS. 13, 14, 15 and 16 is yet another inner container 4 for use with this preferred embodiment. The inner container 4 has a frame 23 supporting one or more independent boxes 24. Two end wheels 22 are rotatably connected to the frame 23.

Back to FIGS. 1 and 2, the solar tube 1 has a sleeve 13 covering on the close end 1a thereof. The sleeve 13 has an axle 12 rotatably supported by a strut 7 through a bearing 11. The axle 12 is able to be driven by a driving mechanism. The sleeve 13 is able to be driven by the driving mechanism to rotate round the axle 12, thus driving the solar tube 1 to rotate accordingly. The cover 5 is fixed on the strut 7 and the inner container 4 is fixed to the cover 5. When the sleeve 13 and the solar tube 1 rotate, the inner container 4 and the cover 5 are stable. The strut 7 can be a framework having a certain elasticity for buffering some forces produced from the rotation of the solar tube 1. The cover 5 can be made of resilient materials such as silicon rubber.

The cover 15 has a circular groove 15 and a vent 6 defined therein respectively for receiving the open end 1b of the solar tube 1 and ventilating steam from the solar tube 1 to outside. The solar tube 1 is made of glass and has a translucent outer layer 11, a blackbody inner layer 3 and a vacuum space 2 between the outer layer 11 and the inner layer 3. The solar tube 1 is able to rotate round the axle 12 of the sleeve 13, i.e. axis A-A1 as shown in FIG. 1, under driving force from the driving mechanism. The open end 1b rotates in the circular groove 15 as the solar tube 1 rotates. Another bearing may be provided in the circular groove 15 in order to reduce friction between the open end 1b and the circular groove 15.

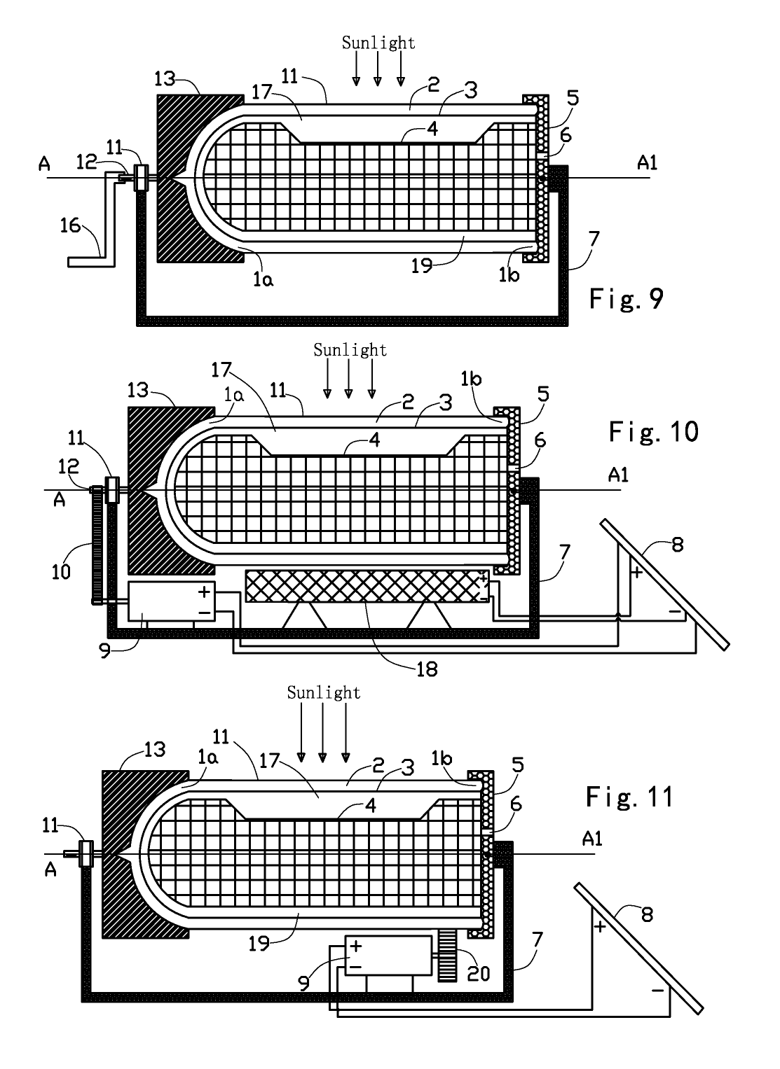

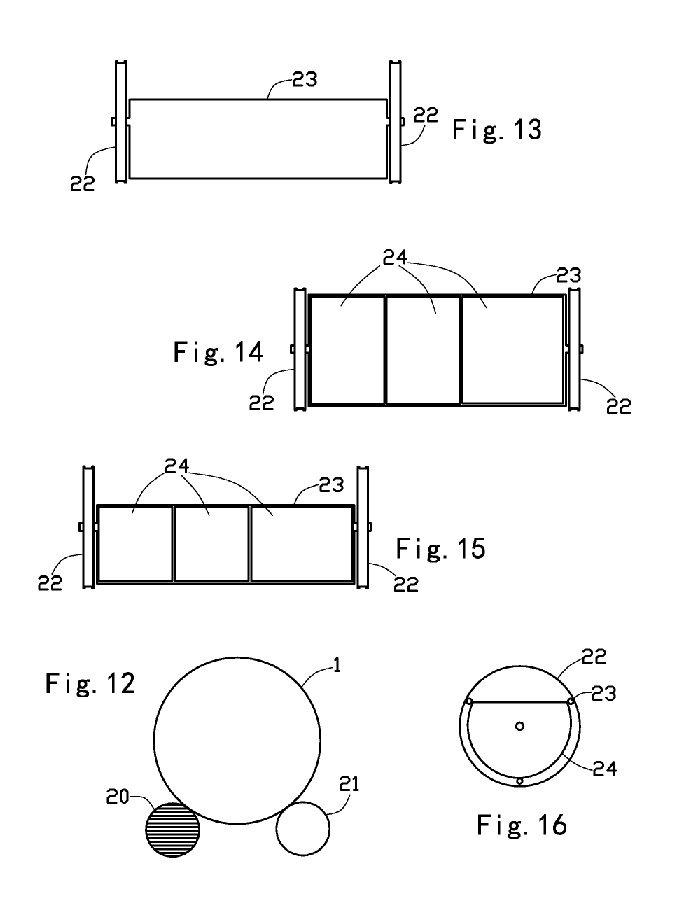

The axle 12 is able to be driven either by an electric motor 9 via a transmission belt 10 or a handcrank 16 as shown in FIG. 9. The electric motor 9 is able to be fixed on the strut 7. As shown in FIGS. 11 and 12, the axle 12 is installed to the strut 7 with the bearing 11 and a free end of the solar tube 1 is supported on a separate driving roller 20 and a driven roller 21. The driving roller 20 is able to be driven to rotate by the electric motor 9, thus driving the solar tube 1 rotate round the axle 12.

As a choice, the electric motor 9 is able to be electrically connected to a solar battery 8 as a power source.

In use, a user is able to put food into the inner container 4 via the top opening 14 and pour some water into the solar tube 1. Quantity of the water should be suitable for steaming the food, for example, between ¼-⅛ of a cross-sectional area of the solar tube 1. Then the user is able to put the inner container 4 into the solar tube 1 and then close the cover 5. Then the solar tube 1 containing the food is able to be put on the strut 7. The solar tube 1 will be driven to rotate round the axle 12 under the electric motor 9. Because of the elasticity of the strut 7, the circular groove 15 of the cover 5 press the open end 1b of the solar tube 1 with a certain force, ensuring the water contained in the solar tube 1 will not leak through the circular groove 15 of the cover 5. When sunlight shines down on the solar tube 1, upper portion of the blackbody inner layer 3 is heated by the sunlight and has got a high temperature. The vacuum space 2 makes a loss of heat very small. When the solar tube 1 rotates under the electric motor 9, the heated upper portion of the blackbody inner layer 3 comes to a lower portion, where the water is able to be heated to boiling. Steam produced from the boiling water will heat the food contained in the inner container 4. A small portion of the steam will ventilate out through the vent 6 and a large portion of the steam will be condensed and drop back to the lower portion of the solar tube 1.

With reference to FIG. 10, another embodiment of the solar steam cooker of the invention is shown. The main difference between this and the aforementioned preferred embodiment is that the solar steam cooker further has an electromagnetic heating panel 18 provided under the solar tube 1. The electromagnetic heating panel 18 may be supported on the strut 7 and leave a certain space to the solar tube 1 in order for facilitate the rotation of the solar tube 1. The electromagnetic heating panel 18 may be powered by the solar battery 8 or an external source power. The blackbody inner layer 3 of this embodiment is magneto conductive by, for example, putting magneto metals into the blackbody materials or coating blackbody materials on magneto metals. More than one coil is provided in the electromagnetic heating panel 18, which is able to produce a magnetic field when electric current passes the coil. The magnetic field is able to make the magneto metal heat up. The magneto metal will be able to heat the food contained in the solar tube 1. The magneto metal may be iron, cobalt, or nickel. The electromagnetic heating panel 18 can be used in cloudy or dull days. The rotation of the solar tube 1 can be achieved either by the motor 9 powered by the solar batter 8 or by the hand crank 16.

1. A solar steam cooker comprising:
a solar tube enclosing an inner space and having a close end and an open end, the solar tube being of glass and having a translucent outer layer, a blackbody inner layer and a vacuum space between the outer and the inner layers,
a cover closing the open end, the cover having a circular groove covering on the open end of the solar tube,
an inner container in the inner space of the solar tube and being rotatable with respect to the solar tube, the inner container having a top opening,
a sleeve covering on the close end of the solar tube and having an axle, and,
a strut supporting the axle of the sleeve.

2. The solar steam cooker as claimed in claim 1, wherein the axle is driven by an electric motor.

3. The solar steam cooker as claimed in claim 1, wherein the axle is driven by a hand crank.

4. The solar steam cooker as claimed in claim 2, wherein the electric motor is electrically connected to a solar battery as a power source.

5. The solar steam cooker as claimed in claim 1, wherein the cover has a vent defined therein.
